(19) United States
(12) Patent Application Publication
(10) Pub. No.: US 2005/0217596 A1
(43) Pub. Date: Oct. 6, 2005

(54) Novel health food and drink containing marine algae

(75) Inventors: Hiroshi Hagino, Tokyo (JP); Shiho Sato, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHIRAKO CO., LTD, Tokyo (JP)

(21) Appl. No.: 11/078,306

(22) Filed: Mar. 14, 2005

(30) Foreign Application Priority Data
Mar. 15, 2004 (JP) 2004-72417
Jan. 25, 2005 (JP) 2005-17148

(51) Int. Cl. A01K 61/00

(52) U.S. Cl. 119/223

(57) ABSTRACT

The object of the present invention is to provide marine algae powder for food and drink or granulated substance thereof, wherein abundant nutritional ingredients and health functional ingredients of Porphyra marine algae and Undaria marine algae are preserved as they are, while the odor contained in the marine algae is effectively abated or reduced, or to provide a powdered drink or food containing the marine algae powder wherein the marine algae powder for food and drink or the granulated substance thereof is used.

The present invention comprises making a marine algae powder for food or drink and granulated substance thereof where nutritional ingredients and health functional ingredients of Porphyra marine algae and Undaria marine algae are preserved as they are, while the smell of the sea of the marine algae is abated, by powdering Porphyra marine algae and/or Undaria marine algae, and mixing powdered tea leaf into the marine algae powder. By preparing the marine algae powdered drink or the food containing the marine algae powder using the marine algae powder for food and drink of the present invention, powdered drink of Porphyra marine algae and Undaria marine algae or the food containing the marine algae powder, whose smell of the sea is abated or reduced, can be provided.

### TECHNICAL FIELD

The present invention relates to novel health food and drink which contains marine algae powder of laver and Undaria, comprise both health functionality and abundant nutritional ingredients, and whose smell is improved. That is, the present invention provides food and drink such as food and powdered drink whose characteristic smell/flavor of marine algae (in otherwords, smell of the sea) is reduced or abated by mixing a certain or more quantity of tea leaf powder into Porphyra marine algae powder and/or Undaria marine algae powder. The present invention relates to novel food and drink, wherein reduction of the smell of the sea enables us to take effectively both of nutritional ingredients and health functional ingredients contained in these marine algae from the food and drink.

### BACKGROUND ART

When Porphyra marine algae powder or Undaria marine algae powder is suspended in water to be provided as food and drink, the food and drink are tasty because of free amino acids but they have a characteristic odor of marine algae, in other words the smell of the sea, so it is extremely difficult to take a certain or more quantity of them continuously. Even though there were cases where these marine algae were used in powder form, when they were used as food, powdered drink (powder for preparing drink) or drink, only tiny quantity of them could be added thereto, and there was restriction in their use, accordingly.

Various studies aiming at reduction of the smell of the sea have been conducted. That is to say, the methods have been proposed, e.g., a method for effecting adsorption treatment of marine algae extract by passing the extract through two types of columns, one of which is filled with granular wood-based activated carbon and another is filled with granular coconut shell-based activated carbon (Japanese Laid-Open Patent Application No.10-120522), and a method for performing treatment of marine algae extract with activated carbon and cationic ion-exchange absorbent (Japanese Laid-Open Patent Application No. 2000-10947). Further, a method for making marine algae extract contact with a synthetic polymer adsorbent to abate the smell has been reported (Japanese Laid-Open Patent Application No.2003-144102). All of above methods are deodorizing methods for eliminating odorous components of the marine algae extract. Consequently, they include a problem of eliminating valuable ingredients of marine algae such as nutritional ingredients at the same time as eliminating odorous components of marine algae; hence the valuable ingredients of marine algae per se could not be utilized in these methods. As methods for deodorizing, since it is performed with food and drink, methods for treating with high safety as well as simple methods for deodorizing which requires as low cost as possible is desirable. In relation to such a point of view, there is a disclosure that marine algae or its powder can be deodorized by performing roast process on them beforehand (Japanese Laid-Open Patent Application No. 2003-304830). When the powdered drink was examined in fact for its practical use, after marine algae or its powder treated by roast process, the smell of the sea could be reduced slightly at least in laver, but a burnt smell was appeared, so there was a problem for practical use.

Additionally, Porphyra marine algae and Undaria marine algae are excellent food containing nutritional ingredients such as proteins, minerals, and vitamins abundantly in a well-balanced manner. Various studies to utilize nutritive value of marine algae have been conducted. That is to say, food in which marine algae are used in combination with many kinds of natural food materials from consideration of nutritious balance are reported such as: a natural antioxidant food prepared by combining natural antioxidative materials or the like with 15 or more kinds of natural food materials such as marine algae, vegetables, cereals, beans, grains, teas, fruits, egg, and mushrooms in view of nutrition (Japanese Laid-Open Patent Application No.10-75740), and nutrition-balanced food containing powder mixture of marine algae, small fishes, and tea leaf (Japanese Laid-Open Patent Application No. 2001-309762). They are mixed in order to supplement nutrient or antioxidative property in a comprehensive manner merely and the effect of mixing is not considered at all from the view point of making marine algae easily usable as food by abating or reducing the smell of the sea. In other words, it is not too much to say that it is the smell of the sea contained in marine algae that causes problems in taste and flavor when food and drink are prepared by using marine algae, and that prevents addition and utilization of marine algae in a certain quantity sufficient for exerting excellent nutritive value contained in marine algae. Particularly, the problem in taste and flavor worsens when drink is prepared by using marine algae, in fact. Even when marine algae or marine algae powder is used as an ingredient of drink, it can be added in only small quantity.

Meanwhile, there is a report concerning examination for antihypertensive action and lowering action on cholesterol and triglyceride levels regarding no less than 26 kinds of marine algae with the use of rat, as to health functionality of marine algae or its powder (Fisheries Science, 60(1), 83-88, 1994). In this report, again, mere health functionality of marine algae is reported.

<Cited Document in the Above Description of Background Art>

(Patent Document 1) Japanese Laid-Open Patent Application No. 10-75740.

(Patent Document 2) Japanese Laid-Open Patent Application No. 10-120522.

(Patent Document 3) Japanese Laid-Open Patent Application No. 2000-109407.

(Patent Document 4) Japanese Laid-Open Patent Application No. 2001-309762.

(Patent Document 5) Japanese Laid-Open Patent Application No. 2003-144102.

(Patent Document 6) Japanese Laid-Open Patent Application No. 2003-304830.

(Non-patent Document 1) Fisheries Science, 60(1), 83-88, 1994.

### DISCLOSURE OF THE INVENTION

Porphyra marine algae and Undaria marine algae are nutritious and tasty marine algae containing proteins, vitamins, and minerals abundantly. Typically and conventionally, they are eaten as ingredients in Japanese cooking: laver is served with being roasted as roasted laver, and Undaria pinnatifida (wakame seaweed) is served with being dressed with Sanbaizu (three-flavored vinegar) or served as substances in miso soup. A novel and simple method for taking marine algae, for instance, a method where these marine algae are ground and suspended in water, then the suspension is served as drink, is also come up with, but a strong characteristic smell of the sea of marine algae, makes it difficult to take it in a certain or more quantity continuously, therefore it has not been put into practical use as drink. Although there were cases where these marine algae were used as ingredients of drink, only small quantity of them were added to other food materials or marine algae because of their characteristic smells or tastes. Then, the present inventors thought that development of technique allowing enriched nutritional ingredients contained in these marine algae to be utilized sufficiently by abating or reducing this smell of the sea of Porphyra marine algae and Undaria marine algae will expand the practical use of these marine algae in food and drink.

Hence, the object of the present invention is to provide marine algae powder for food and drink and preparation thereof such as granulated substance, where odor of the marine algae, in other words, the smell of the sea is effectively abated or reduced while abundant nutritional ingredients and health functional ingredients of Porphyra marine algae and Undaria marine algae such as proteins, carbohydrate, vitamins, minerals, dietary fiber, and phospholipids are preserved as they are. It is also to provide powdered drink of Porphyra marine algae and Undaria marine algae and food and so on added the marine algae powder for food and the like whose smell of the sea is effectively abated or reduced, by using the marine algae powder for food and drink.

After a keen study to attain the above-mentioned object, the present inventors found that nutritional ingredients and health functional ingredients of Porphyra marine algae and Undaria marine algae can be preserved as they are and marine algae powder for food and drink whose smell of the sea can be abated by powdering Porphyra marine algae and Undaria marine algae and mixing powdered tea leaf into the marine algae powder, and thus the present invention has been completed. By using the marine algae powder for food and drink of the present invention, not only nutritional ingredients and health functional ingredients of Porphyra marine algae and Undaria marine algae but also those of tea leaf can be utilized in combination, so the marine algae powder has a high utility value as food and drink showing their health functionality. In addition, the marine algae powder for food and drink of the present invention can be provided in the form of preparation or the like which is prepared by granulating the marine algae powder. In the present invention, by making the marine algae powder whose smell of the sea is effectively abated or reduced as marine algae powdered drink, the utilization of Porphyra marine algae and Undaria marine algae as powdered drink, which was conventionally difficult because of the smell, became possible, and the provision of marine algae powdered drink with high nutritional value and health functionality became possible by mutual action with tea leaf ingredients. Moreover, the present invention made it possible to provide food containing the marine algae powder whose smell of the sea is abated, which contains the marine algae powder or a granulated substance thereof into which tea leaf powder is mixed as a major ingredient, or to which marine algae powder or a granulated substance thereof is added.

The smell of the sea from marine algae can be abated or reduced effectively e.g. when the powder is mixed into water and the mixture is served as drink, by adding tea leaf powder by 30% by weight or more of all ingredients of marine algae powder and the leaf powder into Porphyra marine algae powder and Undaria marine algae powder. Further the present invention includes the use of fine powders of Porphyra marine algae powder and Undaria marine algae powder, and by using the fine powders of Porphyra marine algae powder and Undaria algae powder, nutritional ingredient such as proteins, carbohydrate, vitamins, minerals, dietary fiber, phospholipids contained in marine algae can be digested and absorbed more effectively, and yet fluidity of blood is improved by using any kind of water including tap water. Furthermore, inhibition of platelet aggregation is observed and an effect such as an action of relieving constipation is promoted because they contain dietary fiber from marine algae in quantity. As such, the present invention provides Porphyra marine algae powder and Undaria marine algae powder with enriched nutrient and health functionality, whose smell of the sea is reduced, and makes it possible to utilize Porphyra marine algae and Undaria marine algae by using the marine algae powder as powdered drink. The marine algae powder for food and drink and the granulated substance thereof of the present invention are used for food such as frikake (seasoned dried food for sprinkling over cooked rice), chazuke (seasoned dried food for sprinkling over cooked rice with hot tea poured thereon), tea-buckwheat noodles, soup, miso-soup, sweets and snack food, and other general food as ingredient thereof as well as for drink, to make it possible to provide food containing marine algae whose smell of the sea is abated.

Specifically, the present invention relates to a marine algae powder for food or drink or granulated substance thereof whose smell of the sea, a characteristic smell of marine algae, is abated, which is produced by a method wherein tea leaf powder is mixed into Porphyra marine algae powder and/or Undaria marine algae (wakame seaweeds) powder (“1”); a marine algae powdered drink containing the marine algae powder according to “1” as a major ingredient, whose smell of the sea is abated, (“2”); the marine algae powdered drink according to “2” whose smell of the sea is abaited, which is produced by a method wherein the tea leaf powder in a quantity equivalent to 30% (w/w %) or more of the total quantity of the mixture is added into Porphyra marine algae powder and/or Undaria marine algae powder (“3”); the marine algae powdered drink according to “2” or “3” whose smell of the sea is abated, which is produced by a method wherein the tea leaf powder in a quantity equivalent to 30-60% (w/w %) of the total quantity of the mixture is added thereto (“4”); and the marine algae powdered drink according to anyone of “2”-“44” whose smell of the sea is abated, which is produced by a method wherein powder of Porphyra marine algae and/or Undaria marine algae which are ground so that it has a mean particle diameter of 150 μm or less and tea leaf powder are mixed together (“5”).

The present invention further relates to a food containing the marine algae powder whose smell of the sea is abated, which contains the marine algae powder or granulated substance thereof according to “1” as a major ingredient, or to which the marine algae powder or a granulated substance thereof according to “1” is added (“6”); the food containing marine algae powder whose smell of the sea is abated according to “6”, wherein the tea leaf powder in a quantity equivalent to 30% (w/w %) or more of the total quantity of the mixture in the mixture of Porphyra marine algae powder and/or Undaria marine algae powder and tea leaf powder, is added thereto, or the granulated substance thereof is added thereto, (“7”); a food or drink, which contains the marine algae powder or the granulated substance according to “1” as a major ingredient, and has one or more of following functions: a function of relieving constipation, a function of improving fluidity of blood, a function of inhibiting palatelet aggregationm and a function of immunostimulating (“8”); and the drink according to “8”, which comprises one or more of following functions: a function of relieving constipation, a function of improving fluidity of blood, a function of inhibiting platelet aggregation, and a function of immunostimulating, wherein the drink is a marine algae powdered drink whose smell of the sea is abated (“9”).

### BEST MODE FOR CARRYING OUT THE INVENTION

The present invention comprises making a marine algae powder where nutritional ingredients and health functional ingredients of Porphyra marine algae and Undaria marine algae are preserved as they are, while the smell of the sea of the marine algae is abated, by powdering Porphyra marine algae or Undaria marine algae and mixing powdered tea leaf into the marine algae powder. The marine algae powder for food and drink of the present invention can be provided as preparation in granulated form by granulation. The marine algae powder for food and drink of the present invention is a powder mixture of marine algae powder belonging to Porphyra marine algae or Undaria marine algae powder and tea leaf powder preferably, wherein the tea leaf powder in a quantity equivalent to 30% (w/w %) or more of the total weight is added thereto. The marine algae powder can be used as drink and the like by mixing it with water when needed, or it can be used as food containing marine algae by adding the marine algae powder into food. The marine algae powder for food and drink of the present invention can preserve active ingredients such as nutritional ingredients e.g. proteins, carbohydrate, minerals, vitamins, phospholipids, and dietary fiber as they are and health functional ingredients from marine algae, those ingredients can be utilized effectively in consequence. For example, in the marine algae powder for food and drink of the present invention, health functionalities, such as relieving constipation, improving fluidity of blood, and inhibiting platelet aggregation are exerted along with nutritional ingredients at the same time. Meanwhile, marine algae powder alone has a characteristic odor of marine algae but coexistence of a certain quantity of tea leaf powder with the marine algae powder can reduce the odor effectively; it was not until the above was found that the utilization of powdered health drink, health food, or the like whose odor is reduced was provided.

Porphyra marine algae used in the present invention are selected from Porphyra yezoensis, P. tenera, P. pseudolinearis, P. umbilicalis, P. suborbiculata, and other Porphyra marine algae served for food. Undaria marine algae are selected from Undaria pinnatifida, U. undarioides, U. peterseniana, and other related species of Undaria marine algae.

Raw marine algae or salt curing thereof dried naturally or mechanically after washed are typically used as marine algae. As to these marine algae, dried marine algae are cut into small and narrow slips, and then ground by a grinder so that it has a mean particle diameter of at most 150 μm or less. It is not suitable that the particle diameter of the powder is too large or too small; a particle diameter of powder where part of its cell walls is damaged or so, or a particle diameter of 30-150 μm is preferable. It is because that powder having large particle diameter causes insufficient digestion, whereas powder having too small particle diameter causes elution of viscous polysaccharide when it is dissolved into water, which leads that the drink is not drunk easily due to increase of viscosity. As for a grinder, a mechanical grinder such as a roller mill, a cutter mill, a hammer mill, or the like, a pneumatic grinder such as a jet mill, or a blade mill-type grinder with rotating blades can be used.

As a method for sterilization of the marine algae powder, a method where dried marine algae are heated or sterilized with high-pressure steam in advance and then ground may be applied, and a method where they are ground in advance and then sterilized with heat or high-pressure steam may also applied. It was observed as the result of determination by using model multienzyme system that the marine algae powder of the present invention has higher digestibility when the marine algae powder has a mean particle diameter of 100 μm or so compared to that without being ground. That is, when change of digestibility was studied from the view point of production of reducing sugar in peptic juice by carrying out artificial digestion test with protease, 58-59% of digestibility was seen by digesting the ground laver with pancreatin, whereas 44-45% of digestibility was seen by digesting it with pepsin, six hours later. On the other hand, 44-45% of digestibility was seen by digesting not-ground laver narrow slips with the former, whereas 24-27% of digestibility was shown by digesting it with the latter. Significant improvement in digestibility was thus observed.

Typically, marine algae emit its characteristic smell/taste, in other words a smell of the sea when they contain water, and the odor has a tendency that it strengthens in proportion to the temperature rise. As the smell of the sea is strong odor/taste, there are few people who like it. Especially, there is a tendency that takers feel more and more unpleasant as they take it orally and continuously. When laver is selected from Porphyra marine algae and used, some people do not feel unpleasant so much at first because of palatability by the effect of free amino acid contained in laver, but the odor/taste will become unpleasant after continuous intake. Various deodorization processes have been studied as to methods for abating or reducing the smell of the sea, but a simple, safety, and excellent method which can be used for food and drink has not been found yet. In other words, methods such as processes with activated carbon, resin, polymer adsorbent and the like can be used for deodorizing when marine algae extract is used, but part of amino acids, minerals, and vitamins is adsorbed and lost. Further it cannot be used when marine algae powder per se is used. Marine algae powder can be used in the afore-mentioned method where marine algae are roasted at high temperature (Japanese Laid-Open Patent Application No. 2003-304830) but the examination of the method revealed that the smell of the sea was not reduced significantly at least for laver and excessive roast in order to abate the smell of the sea caused a burnt smell, so it turned out that the method was not for practical use.

As for tea leaf powder used in the present invention, various types of tea leaf powder were applied and they were added to marine algae powder for examination. More specifically, various types of tea leaf powder were mixed into marine algae powder in a certain quantity, and 100 ml of tap water was added to 3.5 g of the powder mixture. Table 1 shows the result of the evaluation by 5 people for the drink prepared as described above. It was shown that the smell of the sea can be generally reduced or abated, even if the marine algae powder is suspended in water, by adding tea leaf powder such as green tea e.g. green tea of middle grade (sencha), refined green tea (gyokuro), ground tea (maccha), pan-fried tea (kamairicha), and coarse tea (bancha), red tea, oolong tea, pu-erh tea, and other various types of tea, to the marine algae powder. It is desirable for quantity of tea leaf added to the marine algae powder that it is in a quantity equivalent to 30% (w/w %) or more of the total weight of the mixture generally, and that it is in a quantity equivalent to 40% (w/w %) or more of the total weight of the mixture in order to abate the smell of the sea rigorously. Quantity of various types of tea added to the marine algae powder used to reduce the odor of the marine algae in the present invention is at least in a quantity equivalent to 30% (w/w %) or more of the total weight of the mixture. It turned out that it is necessary to mix tea leaf into the conventional marine algae at the same or higher concentration to the marine algae powder as or than those shown in the examples of food enhanced antioxidative property, for the purpose of reducing the smell of the sea in order to improve nutrient balance and to add tea leaf powder.

Though reduction level of the smell of the sea depends on the type and grade of the tea used therein and kinds of marine algae; addition of tea leaf powder in a quantity equivalent to 30% of the mixture caused significant reduction of the smell of the sea typically, and addition of tea leaf powder in a quantity equivalent to 40-80% of the mixture prevented the smell of the sea from being sensed almost completely in the examination. However, increase of the quantity of tea leaf added to the mixture strengthens astringent taste of tea leaf, and reduction of the quantity of marine algae added to the mixture also reduces nutritional ingredients and health functional ingredients of marine algae, so it causes deviation from the purpose of nutritious and functional food of the present invention. Therefore it can be said that the quantity of tea leaf powder added to the mixture desirably takes the range of 30-60% equivalent to the mixture. Almost similar result was obtained from a similar examination with Undaria pinnatifida powder.

TABLE 1

| | Existence of Smell of the Sea | | | | | | |
|---|---|---|---|---|---|---|---|
| | Quantity of Added Tea Leaf Powder | | | | | | |
| | (Tea/Tea+ Laver) w/w % | | | | | | |
| Types of Tea | 0 | 20 | 30 | 40 | 50 | 60 | 80 |
| Green Tea of Middle | +++ | +++ | + | ± | − | − | − |
| Grade | | | | | | | |
| Refined Green Tea | +++ | +++ | + | ± | − | − | − |
| Ground Green Tea | +++ | +++ | + | ± | − | − | − |
| Coarse Green Tea | +++ | +++ | + | ± | − | − | − |
| Red Tea | +++ | +++ | + | ± | − | − | − |
| OolongTea | +++ | +++ | + | ± | − | − | − |
| Pu-erh Tea | +++ | +++ | + | ± | − | − | − |

(Symbols +++, +, ±, and − represent the levels of smell of the sea.)

In order to mix tea leaf powder into marine algae powder uniformly, it is desirable that the particle diameter of marine algae powder and that of tea leaf powder are close each other though they are not necessarily the same. They may be ground after mixed, but they may also be ground separately before mix and then mixed.

The powder mixture of marine algae and tea leaf of the present invention or granulated substance thereof can be used as food containing marine algae, or drink, by addition of water when served. When drink is prepared by adding water to the powder mixture of marine algae and tea leaf, or food containing marine algae is prepared by adding the marine algae powder, it is required to be sterilized sufficiently by heating for preservation, which prevents from microbial contamination but loses nutritional ingredients partially, and further the product will require to be kept at low temperature for conservation of nutritional ingredients when transported or kept. In consequence, the powder mixture is preserved in the form of powder with the condition of low water activity, and it is desirable to make the powder mixture into food containing marine algae powder, and drink, by adding water when served. Any water which can be served for drinking such as tap water and treated tap water thereof, mineral water, and the like can be used for water added thereto without problems especially. Other than marine algae powder and tea leaf powder, flavor components such as various types of sugars, salts, and organic acids, and nutritional ingredients such as various types of amino acids and vitamins can be additionally supplemented and enhanced, and one or more of various health functional ingredients such as lactic acid bacteria, herbs, and the like can also be added thereto.

The food containing the marine algae powder, or the drink, used in the present invention, which contains Porphyra marine algae powder or Undaria marine algae powder and tea leaf powder, has enriched nutritional ingredients such as amino acids, vitamins, minerals and the like as mentioned above, and the food containing the marine algae powder, or the drink, are excellent not only in nutrient value but also in health functionality. For example, it was observed that the food containing the marine algae powder, or the drink have an effect of relieving constipation because of dietary fiber contained abundantly in Porphyra marine algae and Undaria marine algae, and the food containing the marine algae powder, or the drink have an effect of reducing blood viscosity because of minerals and phospholipids ingredients also contained in these marine algae. An effect of inhibiting platelet aggregation was observed as well though the ingredient causing the effect has not been elucidated yet. Further, an effect of promoting immunity by sulphated polysaccharides was observed. It is also presumed that the food containing the marine algae powder, or drink, comprise an effect of lowering cholesterol by polysaccharides similarly, an effect of lowering blood pressure and an effect of improving hepatic function by generation of peptides caused by partial digestion of protein. It is assumed that these health functionalities appear, because cell walls are damaged by grinding the marine algae powder so that it has a smaller particle diameter than a certain one, which results in more absorption of the marine algae ingredients.

The present invention will be described more specifically with examples below, but the technical scope of the present invention will not be limited to these exemplifications.

### EXAMPLE 1

Marine algae powder was prepared by cutting 20 kg of roasted laver into narrow slips and grinding them by a jet mil. Then 20 kg of similarly ground tea leaf powder was mixed into the marine algae powder, thus 40kg of the powder mixture was obtained. Powdered drink was produced by adding 50 g of fructose to 500 g of the powder mixture. Marine algae drink was prepared by adding 100 ml of tap water to 3.5 g of the powdered drink. As the result of tasting, almost no characteristic smell of the sea of marine algae was sensed. In this example, marine algae drink was prepared by adding tap water; it is also possible to prepare the drink by dissolving or mixing the powdered drink into dairy product such as milk and yogurt, soymilks, various kinds of juices, and other drinks other than water.

### EXAMPLE 2

Marine algae powder was prepared by grinding 60 kg of dried laver by a blade mil and sterilizing it with high-pressure steam. Powdered drink was produced by mixing 200 g of similarly ground coarse tea powder into 300 g of the powder, and further mixing 125 g of powder sugar into the powder mixture.

### EXAMPLE 3

Six types of powder mixture of laver and tea leaf each of which weigh 600 g were obtained, where 300 g of refined green tea (gyokuro), green tea of middle grade (sencha), red tea, oolong tea, and pu-erh tea were mixed into 300 g of laver powder of Example 1, respectively. Respective drinks were prepared by adding 100 ml of mineral water to 3.5 g of the respective powder mixture and tasted. Almost no characteristic smell of the sea of marine algae was sensed with any sample.

### EXAMPLE 4

Marine algae powder was prepared by cutting dried Undaria pinnatifida, powdering them by a jet mil and sterilizing them with high-pressure steam. Then, 200 g of green tea of middle class (sencha) was mixed into 300 g of the sterilized marine algae powder, and thus 500 g of powdered drink mixture was obtained. Powdered drink was produced by adding 125 g of fructose to 500 g of the powder.

### EXAMPLE 5

Powder drink was produced as follows: 3 kg of green tea of middle class (sencha) leaf powder was added to 3 kg of roasted laver ground by a blade mill so that the powder had a mean particle diameter of 60 μm, the powder was agitated and mixed, then the powder mixture was divided by a dose of 3.5 g, and the respective doses were packed individually. Next, 100 ml of tap water was added to the powdered drink, and the solution was agitated and taken by two persons once in the morning and once in the evening i.e. twice a day for one week. They were subjected to blood collecting before taking the powdered drink and one week after taking it. On the days of blood collecting, they did not take breakfast. After 9.5 ml blood was collected from each of them, the blood was dispensed into test tubes into which 0.5 ml of heparin (1000 unit/ml) was added in advance respectively, and agitated, then, time required for passage of blood through slits was measured with 100 μl of it by using a micro channel array flow analyzer (MC-FAN, Hitachi Haramachi Electronics Co., Ltd). As the result shown in table 2, compared to the time required for passage of blood before taking the powdered drink, significant reduction of the time required for passage was observed in both of two persons after taking. It led to the thought that the deformability of erythrocyte was improved by taking the drink.

TABLE 2

Time Required for Passage of Blood (sec)

| | Before Taking | 1 Week after Taking |
|---|---|---|
| A | 45.3 | 40.0 |
| B | 46.7 | 42.1 |

### EXAMPLE 6

The drink was prepared by adding 100 ml of mineral water to 3.5 g of powder mixture of laver and tea leaf shown in Example 1, and taken once in the morning and once in the evening i.e. twice a day for ten days by 20 females who tend to be constipated. They responded to the questionnaires on effect of relieving constipation after taking the drink. The result is shown in Table 3. The result shows that 13 of them (65%) realized an effect of relieving constipation.

TABLE 3

| | Respondents Realizing |
|---|---|
| Level of Improved Constipation | the Effect (Person) |
| Improved | 10 |
| Improved Slightly | 3 |
| Yes and No | 3 |
| Not Improved | 4 |

### EXAMPLE 7

Time required for platelet aggregation was measured by the method described below. That is, human peripheral blood collected in heparin tubes underwent sedimentation for seven min at 1100 rpm, and the supernatant was collected as plate-rich plasma (PRP). Time required for aggregation was measured with an aggregometer (Hematoracer 601, Niko Bioscience Inc.) at 37° C. by nephelometry. ADP was added to 200 μl of PRP so that PRP had the final density of 400 μm, the aggregation response was started, and turbidity was measured over time. The point where turbidity became constant was regarded as the ending point of the aggregation response; the time for aggregation was measured.

The drink was prepared by adding 100 ml of mineral water to 3.5 g of powder mixture of laver and tea leaf shown in Example 2, and the drink was taken by six volunteers (three males and three females) of A, B, C, D, E, and F once in the morning and once in the evening i.e. twice a day for four weeks. Times to reach the ending of blood clumping were measured before taking the drink and four weeks after taking it. As shown in Table 4, significant extension, extension, and almost no change of clumping time were observed in two, another two, and the other two persons respectively as the result.

TABLE 4

Time Required for Aggregation (min)

| | | 4 Weeks after |
|---|---|---|
| | Before Taking | Taking |
| A (Male; Age 64) | 7.50 | 16.80 |
| B (Male; Age 58) | 10.50 | 11.30 |
| C (Male; Age 40) | 8.10 | 23.50 |
| D (Female; Age 60) | 8.20 | 26.50 |
| E (Female; Age 48) | 10.15 | 11.80 |
| F (Female; Age 46) | 6.40 | 11.55 |

### EXAMPLE 8

Powder mixture was prepared by mixing 800 g of salt into 1 kg of roasted laver powder and 1 kg of ground tea leaf powder produced in Example 1, and granules for chazuke was prepared by granulating the powder mixture by extrusion granulator.

### EXAMPLE 9

Granules for adding to yogurt drink was prepared by mixing 120 g of powder sugar into 280 g of the powder mixture of roasted laver powder and ground tea leaf powder produced in Example 1.

### EXAMPLE 10

Cookie dough was prepared by mixing 20 ml of water into 50 g of the roasted laver powder and 20 g of ground tea leaf powder produced in Example 1, 3 g of salt, 20 g of salad oil, 1 raw egg, and 100 g of flour, then kneaded, formed, and baked, and thus cookies were prepared.

### INDUSTRIAL APPLICABILITY

The present invention provides marine algae powder for food and drink and granulated substance thereof, wherein nutritional ingredients and health functional ingredients of Porphyra marine algae and Undaria marine algae are preserved as they are, while the smell of the sea of the marine algae is abated. The marine algae powder for food and drink and granulated substance thereof of the present invention can be utilized not only nutritional ingredients and health functional ingredients of Porphyra marine algae and Undaria marine algae but also those of tea in combination, therefore the marine algae powder for food and drink of the present invention has a high utility value as food and drink with health function. Moreover, in the present invention, by making the marine algae powder for food and drink of the present invention whose smell of the sea is effectively abated or reduced, as marine algae powdered drink, or by making food which contains the marine algae powder for food or drink or a granulated substance thereof as a major ingredient, or to which marine algae powder for food or drink or a granulated substance thereof is added, the utilization of Porphyra marine algae and Undaria marine algae as powdered drink or food containing marine algae powder became possible, which was conventionally difficult because of the smell. The food containing the marine algae powder or the marine algae powdered drink having high utility value with high nutritional value and health functionality can be provided by mutual action with tea leaf ingredients consequently.

1. A marine algae powder for food or drink or granulated substance thereof whose smell of the sea, a characteristic smell of marine algae, is abated, which is produced by a method wherein tea leaf powder is mixed into Porphyra marine algae powder and/or Undaria marine algae (wakame seaweeds) powder.

2. A marine algae powdered drink containing the marine algae powder according to claim 1 as a major ingredient, whose smell of the sea is abated.

3. The marine algae powdered drink according to claim 2 whose smell of the sea is abated, which is produced by a method wherein the tea leaf powder in a quantity equivalent to 30% (w/w %) or more of the total quantity of the mixture is added into Porphyra marine algae powder and/or Undaria marine algae powder.

4. The marine algae powdered drink according to claim 2 whose smell of the sea is abated, which is produced by a method wherein the tea leaf powder in a quantity equivalent to 30-60% (w/w %) of the total quantity of the mixture is added thereto.

5. The marine algae powdered drink according to claim 2 whose smell of the sea is abated, which is produced by a method wherein powder of Porphyra marine algae and/or Undaria marine algae which are ground so that it has a mean particle diameter of 150 μm or less and tea leaf powder are mixed together.

6. A food containing the marine algae powder whose smell of the sea is abated, which contains the marine algae powder or granulated substance thereof according to claim 1 as a major ingredient, or to which the marine algae powder or a granulated substance thereof according to claim 1 is added.

7. The food containing marine algae powder whose smell of the sea is abated according to claim 6, wherein the tea leaf powder in a quantity equivalent to 30% (w/w %) or more of the total quantity of the mixture in the mixture of Porphyra marine algae powder and/or Undaria marine algae powder and tea leaf powder, is added thereto, or the granulated substance thereof is added thereto.

8. A food or drink, which contains the marine algae powder or the granulated substance according to claim 1 as a major ingredient, and has one or more of following functions: a function of relieving constipation, a function of improving fluidity of blood, a function of inhibiting palatelet aggregationm and a function of immunostimulating.

9. The drink according to claim 8, which comprises one or more of following functions: a function of relieving constipation, a function of improving fluidity of blood, a function of inhibiting platelet aggregation, and a function of immunostimulating, wherein the drink is a marine algae powdered drink whose smell of the sea is abated.
